(19) United States
(12) Patent Application Publication
(10) Pub. No.: US 2007/0189672 A1
(43) Pub. Date: Aug. 16, 2007

(54) Method for Preparing Polymeric Optical Waveguide Device

(76) Inventors: Masatoshi Yamaguchi, Tsukuba-shi (JP); Toshihiro Kuroda, Tsukuba-shi (JP); Toshihiko Kanazawa, Tsukuba-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/690,887

(22) Filed: Mar. 26, 2007

Related U.S. Application Data
(63) Continuation of application No. PCT/JP05/20114, filed on Nov. 1, 2005.

(30) Foreign Application Priority Data
Sep. 26, 2005 (JP) 2005-277729

(51) Int. Cl. G02B 6/30

(52) U.S. Cl. 385/49

(57) ABSTRACT

The present invention relates to a method for preparing an optical. waveguide device which comprises a step of forming a V-shaped groove on a substrate; a step of applying a filling polymer-containing coating solution having an NV value of not less than 35% onto the substrate, drying the applied coating solution and then removing the unnecessary filling polymer so that the filling polymer remains only in the V-shaped groove; forming an optical waveguide consisting of a polymer on the substrate; a step of making a cut at a position corresponding to the end face of the optical waveguide; and a step of removing all the polymer present in and on the V-shaped groove. The method permits the solution of such a problem that when preparing an optical waveguide device, a coating solution of a polymer used for forming the core and clad layers thereof undergoes sagging and running towards the openings of the neighboring V-shaped grooves so that the level of the core center is lower than the designed level thereof and the method thus permits the production of an optical waveguide device completely free of any deviation of the core center.

### TECHNICAL FIELD

The present invention relates to a method for the preparation of a polymeric optical waveguide device and more particularly to a method for the preparation of a polymeric optical waveguide device provided with a V-shaped groove used for mounting optical fibers on the substrate of the optical waveguide device.

### BACKGROUND ART

There has rapidly been increased the demand for information transmission along with the recent wide spread of personal computers and the internet. For this reason, it has been desired to spread the optical transmission system having a high transmission rate even to terminal information-processing units such as personal computers. The realization thereof would certainly require the production of high quality optical waveguides used for the optical inter-connection, in large quantities and at a reasonable price.

As materials for the optical waveguide, there have been known a variety of substances, for instance, inorganic materials such as glass materials and semiconductor materials; and resins.

Various kinds of resins have been known as materials for forming optical waveguides and polyimide has attracted special interest, among others, because of its high glass transition point (Tg) and its excellent heat resistance. When a core and clad layers are formed using polyimide materials, the resulting optical waveguide would have good reliability over a long period of time and can withstand even the soldering operations. Among such polyimide materials, fluorine atom- containing ones have usually been employed because of their excellent transmittance and refraction characteristics. An optical waveguide can be prepared from such a resin by, for instance, first putting a core layer on top of a lower clad layer, forming a core pattern by a method such as the photolithography technique and then forming an upper clad layer on the patterned core layer.

When using an optical waveguide provided with core and clad layers in the optical inter-connection, an optical waveguide is formed on a substrate provided with a groove called V-shaped groove formed thereon and used for the connection thereof to an optical fiber and the end face of the optical waveguide is connected to such an optical fiber fixed on the V-shaped groove.

However, it has been observed that the core center of the optical waveguide formed on a substrate provided with such a V-shaped groove deviates from the center of the optical fiber to be connected and that this accordingly results in the generation of an optical coupling loss. The inventors of this invention have found that, upon the preparation of an optical waveguide, a coating solution of a polymer used for forming the core or clad layer thereof undergoes sagging and running into or towards the openings of the neighboring V-shaped grooves to thus partially fill in the openings, so that the level of the core center is lower than the designed level thereof to thus cause the deviation of the core center or the altitude gap between the observed level of core center and the designed level of core center.

In this connection, there has conventionally been reported a method for covering V-shaped grooves with a flat plate-like member or an SiO₂ film in order to solve the problems associated with this phenomenon such that it is quite difficult to remove the optical waveguide-forming material, which is in the V-shaped grooves and that an exposure pattern for forming bonding pads becomes dim due to the differences in level generated by the V-shaped grooves (see, for instance, Patent Document 1 and Patent Document 2 given below). In addition, there has also been reported a method which comprises the steps of forming a supply reservoir and V-shaped grooves on a substrate, injecting a polymer through the supply reservoir, curing and allowing the polymer to swell, cutting and removing the polymer by, for instance, polishing to thus make the surface precisely smooth and to thus form an optical waveguide and finally removing the polymer present in the V-shaped grooves by the irradiation with a laser beam (see Patent Document 3 specified below). However, the step of such a precise leveling of a polymer by polishing and the step for the removal thereof by the irradiation with a laser beam are not favorable from the viewpoint of the productivity and the production cost thereof.
Patent Document 1: Japanese Un-Examined Patent Publication (hereunder referred to as “J.P. KOKAI”) Hei 6-275870;
Patent Document 2: J.P. KOKAI Hei 7-74342;
Patent Document 3: J.P. KOKAI Hei 6-235835

### DISCLOSURE OF THE INVENTION

It is accordingly an object of the present invention to provide a method for preparing an optical waveguide device, which can solve such a problem that when preparing an optical waveguide device, which comprises a polymer core and polymer clad layers, on a substrate provided with a V-shaped groove used for mounting an optical fiber thereon, a coating solution of a polymer used for forming the core or the clad layers thereof sags and runs towards the openings of the neighboring V-shaped grooves so that the level of the core center is lower than the designed level thereof and which thus never causes any deviation of the core center.

It is another object of the present invention to provide a method for preparing an optical waveguide device, which comprises a polymer core and polymer clad layers, on a substrate provided with a V-shaped groove used for mounting an optical fiber thereon. The method permits the production of an optical waveguide device free of any deviation of the core center and permits the production thereof in a high production efficiency and at a low price.

The inventors of this invention have found that the foregoing problems can be solved by providing a method which comprises the steps of filing the V-shaped grooves with a polymeric material having a relatively high NV (content of non-volatile components) value, forming an optical waveguide and subsequently removing the polymer used for filling the groove.

More specifically, the present invention relates to a method for preparing an optical waveguide device which comprises, on a substrate, an optical waveguide made of a polymer and a V-shaped groove for mounting an optical fiber to be connected to the optical waveguide and the method comprises the following steps:
(1) a step of forming a V-shaped groove on the substrate;
(2) a step of applying a filling polymer-containing coating solution having an NV of not less than 35% onto the substrate, drying the applied coating solution, and then removing the unnecessary filling polymer so that the filling polymer remains only in the V-shaped groove;
(3) a step of forming an optical waveguide consisting of a polymer on the substrate;
(4) a step of making a cut at a position corresponding to the end face of the optical waveguide; and
(5) a step of removing all the polymer present in and on the V-shaped groove.

In the step (2) of the foregoing method, it is preferred to use at least two filling polymer-containing coating solutions each having an NV value of not less than 35%, and to repeat, at least two times, the sub-steps of applying each coating solution onto the substrate, drying the applied coating solution, and subsequently removing the unnecessary filling polymer portions, in order to thus form a filling polymer layer.

Moreover, in the foregoing method, the distance between the surface of the filling polymer remaining in the V-shaped groove and the substrate surface is preferably at a level of not more than 20 μm.

Furthermore, in the foregoing method, it is preferred that the filling polymer is a photo-sensitive polyimide.

In addition, the sub-step for the removal of the unnecessary portion of the filling polymer in the step (2) of the foregoing method should preferably comprise exposing the polymer layer to light rays through a mask, developing the exposed polymer layer and curing the same.

Further, the sub-step of curing in the step (2) of the foregoing method is preferably carried out at a temperature higher than the Tg of the filling polymer or the Tg value of the lowermost filling polymer when at least two layers of different filling polymers are present (in other words, if the filling polymer layer comprises at least two layers of different filing polymers, the Tg value of the filling polymer of the lowermost layer).

According to another embodiment of the present invention, the method further comprises a step of applying a peelable layer onto the entire surface of the substrate after (1) the formation of the V-shaped groove and before (2) the application of the coating solution of a filling polymer.

Moreover, in the step (2) of the foregoing method, the sub-step for removing the unnecessary portions of the filling polymer is preferably one in which the filling polymer is removed in such a manner that the polymer remains in the V-shaped groove and on the periphery of the V-shaped groove.

The method of the present invention permits the production of an optical waveguide device provided with a V-shaped groove with an exact position of core center, i.e., the device does not show any significant scattering in the core center position. In addition, the method of the present invention likewise permits the production of an optical waveguide device which does not show any significant scattering in the core center position by a smaller number of steps at a low price. Furthermore, the method of the present invention likewise permits the production of an optical waveguide device which does not show any significant scattering in the core center position at a high yield.

### BEST MODE FOR CARRYING OUT THE INVENTION

A first embodiment of the present invention relates to a method for preparing an optical waveguide device which comprises, on a substrate, an optical waveguide made of a polymer and a V-shaped groove for mounting an optical fiber to be connected to the optical waveguide and the method comprises the following steps:
(1) a step of forming a V-shaped groove on the substrate;
(2) a step of applying a filling polymer-containing coating solution having an NV of not less than 35% onto the substrate, drying the applied coating solution, and then removing the unnecessary filling polymer so that the filling polymer remains only in the V-shaped groove;
(3) a step of forming an optical waveguide consisting of a polymer on the substrate;
(4) a step of making a cut at a position corresponding to the end face of the optical waveguide; and
(5) a step of removing all the polymer present in and on the V-shaped groove.

In the present invention, the term “optical waveguide device” means a device comprising a substrate, a V-shaped groove formed on the substrate and used for mounting an optical fiber on the substrate and an optical waveguide (a core and clad layers) consisting of polymer layers.

The substrate used in the method of the present invention may be any one made of any known material and used as a substrate for the optical waveguide device, but specific examples thereof are substrates made of inorganic materials such as glass, quartz, silicon, silicon oxide, silicon nitride, aluminum, aluminum oxide, aluminum nitride, tantalum oxide and gallium arsenide.

In this specification, the term “polymeric optical waveguide” means an optical waveguide whose core and dads are made of a polymer or polymers.

The polymers which may be used for forming the core and/or clads of an optical waveguide may be any one and specific examples thereof include polyimide resins (such as polyimide resin, poly(imide/isoindolo-quinazoline dione imide) resins, polyether-imide resins, polyether-ketone resins, and polyester-imide resins), silicone type resins, acrylic resins, polystyrenic resins, polycarbonate type resins, polyamide type resins, polyester type resins, phenolic resins, poly(quinoline) type resins, poly(quinoxahine) type resins, poly(benzoxazole) type resins, poly(benzo-thiazole) type resins, poly(benzimidazole) type resins, and resins for photo- bleaching (such as polysilane, nitron compound-containing silicone resins, DMAPN {(4-N,N-dimethylaminophenyl)-N-phenyl nitron}-containing poly(methyl methacrylate), dye polymers, nitron compound-containing polyimide resins or epoxy resins disclosed in J.P. KOKAI 2001-296438, and hydrolyzable silane compounds disclosed in J.P. KOKAI 2000-66051). The foregoing resin may be a fluorine atom-containing resin. Examples of polymers preferably used herein are polyimide resins because of their high glass transition points (Tg) and their excellent heat resistance. Among them, particularly preferred are fluorinated polyimide resins because of their excellent transmittance and their refraction characteristics.

In the method of the present invention, it is essential to use a filling polymer-containing coating solution having an NV value (a content of non-volatile components) of at least 35%. The use of a coating solution of a polymer having such an NV value would permit the improvement in the flatness of the resulting filling polymer present in the V-shaped groove. From the viewpoint of the improvement in the flatness of the polymer when filling the V-shaped groove with the same, the NV value of the coating solution is more preferably not less than 36%, further preferably not less than 38% and most preferably not less than 40%.

The filling polymer used in the present invention is preferably a photo-sensitive polymer while taking into consideration the easiness of the subsequent removal of the unnecessary portion of the polymer. More preferably it is a photo-sensitive polyimide resin composition which is excellent in, in particular, the resistance to chemical attack, the heat resistance and the ability thereof to be easily peeled off.

Usable herein as such a photo-sensitive polymer composition may be either of positive-type and negative-type photo-sensitive polymer compositions. In case where a relatively deep V-shaped groove (such as a groove having a depth of 100 μm) should be filled with such a filling polymer, however, the positive-type photo-sensitive polymer composition is more preferably used herein than the negative-type one from the viewpoint of the reduction of the exposure time for the sensitization thereof and the improvement of the production efficiency.

(Positive-Type Photo-Sensitive Polyimide Composition)

The positive-type photo-sensitive polyimide composition used herein is preferably one comprising the following components (A) and (B) since it is excellent in, in particular, the heat resistance and the peeling ability:
(A) A polyamide acid ester comprising repeating units represented by the following general formula (I): 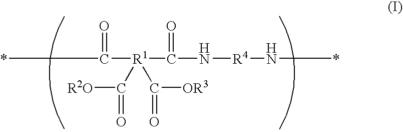
wherein, R¹ represents a tetravalent organic group, R² and R⁸ each represent a hydrocarbon group and R⁴ represents a residue or bis(3-amino-4-hydroxyphenyl) hexafluoro-propane from which the amino group is eliminated;, and
(B) An o-quinone-diazide compound.

The foregoing substituent R¹ preferably represents a tetravalent organic group having a chemical structure to which an aromatic ring or 2 to 3 aromatic rings are linked through at least one linkage selected from the group consisting of single bond, ether bonds, 2,2-hexafluoro-propylene bond, sulfone bonds, methylene bonds and carbonyl bonds.

In addition, the foregoing polyamide acid ester preferably additionally comprises repeating units represented by the following general formula (II): 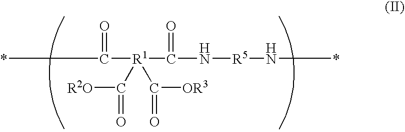
wherein, R¹, R² and R³ are the same as those defined above in connection with Formula (I) and R⁵ represents a divalent organic group having a chemical structure to which an aromatic ring or 2 to 3 aromatic rings are linked through at least one linkage selected from the group consisting of single bond, ether bonds, 2,2-hexafluoro-propylene bond, methylene bonds and carbonyl bonds, provided that it is free of any phenolic hydroxyl group. In this respect, if the number of the repeating units represented by Formula (I) and that of the repeating units represented by Formula (II) are assumed to be m and n, respectively, the ratio of the former to the latter as expressed in terms of the quotient: m/(m +n) preferably ranges from 1.0 to 0.4.

Regarding the component (A), the total number of the repeating units represented by Formulas (I) and (II) preferably ranges from 50 to 100%, more preferably 80 to 100% and particularly preferably 90 to 100% on the basis of the overall number of repeating units present in the composition. The molecular weight of the component (A) as expressed in term of the weight average molecular weight preferably ranges from 3,000 to 200,000 and more preferably 5,000 to 100,000. The molecular weight can be measured according to the gel permeation chromatography technique and can be expressed in terms of the relative value which can be determined using the standard polystyrene calibration curve.

The aforementioned polyamide acid ester may be one prepared by reacting, for instance, a tetracarboxylic acid diester dichloride represented by the following general formula (III) with a diamine compound represented by the following general formula (IV) and/or a diamine compound represented by the following general formula (V): 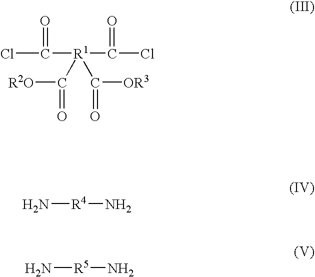
wherein, R¹, R², R³, R⁴ and R⁵ are the same as those defined above in connection with Formulas (I) and (II).

The tetracarboxylic acid diester dichloride represented by Formula (III) can be prepared by any known method such as the method as disclosed in J.P. KOKAI Hei 11-174678.

The compound represented by Formula (IV) is a diamine having at least one phenolic hydroxyl group and preferably used herein are diamines each having a chemical structure to which an aromatic ring or 2 to 3 aromatic rings are linked through at least one linkage selected from the group consisting of a single bond, ether bonds, 2,2-hexafluoro-propylene bond, sulfone bonds and methylene bonds, from the viewpoint of the heat resistance and the mechanical characteristic properties of the polyimide type polymers observed after a heat-treatment. Specific examples of these compounds include 1,3-diamino-4-hydroxy-benzene, 1,3-diamino-5-hydroxybenzene, 3,3′-diamino-4,4′-dihydroxy-biphenyl, 4,4′-diamino-3,3′-dihydroxy-biphenyl, bis(3-amino-4-hydroxyphenyl) sulfone, bis(4-amino-3-hydroxy-phenyl)sulfone, bis(3-amino-4-hydroxyphenyl)hexafluoropropane, and bis(4-amino-3-hydroxyphenyl)hexafluoropropane.

The aforementioned diamine compounds each having at least one phenolic hydroxyl group may be used alone or in any combination of at least two of them.

The compound represented by the foregoing general formula (V) is a diamine and preferably used herein are diamines each having a chemical structure to which an aromatic ring or 2 to 3 aromatic rings are linked through at least one linkage selected from the group consisting of a single bond, ether bonds, 2,2-hexafluoro-propylene bond, sulfone bonds and methylene bonds, from the viewpoint of the heat resistance and the mechanical characteristic properties of the polyimide type polymers observed after a heat-treatment. Specific examples of these compounds include 4,4′-diamino-diphenyl ether, 4,4′-diamino-diphenyl methane, 4,4′-diamino-diphenyl sulfone, benzidine, m-phenylene-diamine, p-phenylene-di-amine, 1,5-naphthalene-diamine, 2,6-naphthalene-diamine, bis(3-aminophenoxy-phenyl)sulfone, 1,4-bis(4-aminophenoxy)benzene, and 4,4′-diamino-2,2′-dimethyl-biphenyl.

The aforementioned diamine compounds may be used alone or in any combination of at least two of them.

The component (B) used in the present invention is an o-quinone-diazide compound. Such an o-quinone-diazide compound may be prepared by, for instance, condensing an o-quinone-diazide sulfonyl chloride with a hydroxyl group-containing compound or an amino group-containing compound in the presence of a catalyst capable of eliminating hydrogen chloride molecules. Examples of such o-quinone-diazide sulfonyl chlorides usable herein are benzoquinone-1,2-diazide-4-sulfonyl chloride, naphthoquinone-1,2-diazide-5-sulfonyl chloride and naphthoquinone-1,2-diazide-4-sulfonyl chloride.

Examples of the hydroxyl group-containing compounds usable herein include hydroquinone, resorcinol, pyrogallol, bisphenol A, bis(4-hydroxyphenyl)methane, 2,2-bis(4-hydroxyphenyl)hexafluoro-propane, 2,3,4-trihydroxy benzophenone, 2,3,4,4′-tetrahydroxy benzophenone, 2,2′,4,4′-tetrahydroxy benzophenone, 2,3,4,2′,3′-pentahydroxy benzophenone, 2,3,4,2′,3′,4′-hexahydioxy benzophenone, bis(2,3,4-trihydroxyphenyl)methane, bis(2,3,4-trihydroxyphenyl)propane, 4b,5,9b,10-tetrahydro-1,3,6,8-tetrahydroxy-5,10-dimethylindeno[2,1-a]indene, tris-(4-hydroxyphenyl)methane, and tris(4-hydroxyphenyl)ethane.

Examples of the foregoing amino group-containing compounds include p-phenylene-diamine, m-phenylene-diamine, 4,4′-diaminophenyl ether, 4,4′-di-amino-diphenyl methane, 4,4′-diamino-diphenyl sulfone, 4,4′-diamino-diphenyl sulfide, o-aminophenol, m-aminophenol, p-aminophenol, 3,3′-diamino-4,4′-di-hydroxy-biphenyl, 4,4′-diamino-3,3′-dihydroxy-biphenyl, bis(3-amino-4-hydroxy-phenyl)propane, bis(4-amino-3-hydroxyphenyl)propane, bis(3-amino-4-hydroxy-phenyl)sulfone, bis(4-amino-3-hydroxyphenyl)sulfone, bis(3-amino-4-hydroxy-phenyl)hexafluoropropane and bis(4-amino-3-hydroxyphenyl)hexafluoropropane.

In the condensation reaction of an o-quinone-diazide sulfonyl chloride with a hydroxyl group-containing compound or an amino group-containing compound, these components are preferably mixed in a ratio such that the total amount of the hydroxyl groups and the amino groups ranges from 0.5 to 1 eq. per one mole of the o-quinone-diazide sulfonyl chloride. In this respect, the ratio of the catalyst capable of eliminating hydrogen chloride molecules to the o-quinone-diazide sulfonyl chloride is believed to be in the range of from 0.95/1 to 1/0.95. The condensation reaction temperature preferably ranges from 0 to 40° C. and the reaction time preferably ranges from 1 to 10 hours. The solvent usable in this reaction may be, for instance, dioxane, acetone, methyl ethyl ketone, tetrahydrofuran, diethyl ether and N-methyl pyrrolidone. Examples of such catalyst capable of eliminating hydrogen chloride molecules usable herein are sodium carbonate, sodium hydroxide, sodium hydrogen carbonate, potassium carbonate, potassium hydroxide, trimethylamine, triethylamine and pyridine.

The relative amounts of the component (B) and the component (A) may discretionally be determined, but the amount of the component (B) preferably ranges from 5 to 100 parts by weight and more preferably 10 to 40 parts by weight per 100 parts by weight of the component () while taking into consideration the difference in solubility between the light-exposed area and the unexposed area and the sensitivity.

The photo-sensitive resin composition can in general be obtained in the form of a solution which comprises the foregoing components (A) and (B) dissolved in a solvent component (C). Examples of such solvent components are aprotic polar solvents such as N-methyl-2-pyrrolidone, N,N-dimethyl formamide, N,N-dimethyl acetamide, dimethylsulfoxide, hexamethyl-phosphoramide, tetramethylene sulfone, γ-butyrolactone, cyclohexanone and cyclopentanone, which may be used alone or in any combination of at least two of them. In this respect, it is sufficient to use the solvent (C) in such an amount that the NV value of the resulting solution is not less than 35%.

Further, the positive-type photo-sensitive polymer composition preferably comprises, for instance, an organic silane compound, an aluminum-containing chelating agent, and a silicon-containing polyamide acid as an auxiliary agent for adhesion. Examples of such organic silane compounds are, γ-aminopropyl tri-methoxy-silane, γ-aminopropyl triethoxysilane, vinyl triethoxysilane, γ-glycidoxypropyl triethoxy-silane and γ-methacryloxy-propyl trimethoxysilane. Examples of the foregoing aluminum-chelating agents are tris(acetyl-acetonate) aluminum and acetyl-acetate aluminum diisopropylate.

When using these additives, the amount thereof to be incorporated into the composition may vary depending on the kinds thereof, but the amount of these additives preferably ranges from 1 to 50 parts by weight and more preferably 2 to 20 parts by weight per 100 parts by weight of the component (A), while taking notice of the adhesion between the film formed and the substrate as well as the tolerance of the rate of remaining film.

(Negative-Type Photo-Sensitive Polyimide Composition)

The negative-type photo-sensitive polyimide composition preferably used in the present invention may be, for instance, a composition comprising (a) a polyimide precursor carrying acidic functional groups in the molecular chain and soluble in an aqueous alkali solution; (b) a sensitizer and (c) a silicon atom-containing compound having a reactive unsaturated functional group and an alkoxy group or an acyloxy group.

Regarding the polyimide precursor carrying acidic functional groups in the molecular chain and soluble in an aqueous alkali solution as a component of the foregoing negative-type photo-sensitive polyimide composition, the acidic functional group may be, for instance, a carboxyl group, a phenolic hydroxyl group and a sulfonic acid residue. Among them, preferably used herein is a carboxyl group since the precursor having a carboxyl group shows good solubility.

In addition, the polyimide precursor preferably possesses photo-sensitive groups. The term “photo-sensitive group” herein used means a group, which can undergo dimerization or polymerization by the action of light rays, and preferably used herein are those each having a carbon-carbon unsaturated double bond among others. When the photo-sensitive resin composition is exposed to light rays, the foregoing component (a) present in the light-exposed area is crosslinked through the dimerization or polymerization of the photo-sensitive group thereof and it is thus converted into component insoluble in an aqueous alkaline solution or hardly soluble therein, while the un-exposed area thereof is still soluble in an aqueous alkaline solution due to the presence of the acidic functional group in the foregoing component (a).

Examples of the components (a) preferably used herein are photo-sensitive polyimide precursor, which comprises repeating units represented by the following general formula (1): 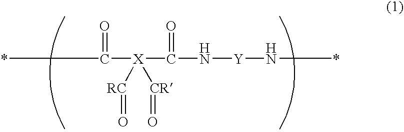
wherein, X represents a tetravalent organic group provided that any atom having an unshared electron pair is not present in the skeleton which links the two amide groups linked to this X; Y represents a divalent organic group provided that any atom having an unshared electron pair is not present in the skeleton which links the two amide groups linked to this Y; and R and R′ each independently represent OH or a monovalent organic group, and which has acidic functional groups and photo-sensitive groups in the molecule.

In the definition of X and Y, the term “skeleton which links the two amide groups” means a skeleton consisting only of atoms constituting the corresponding bonding chain which links the related two amide groups. Therefore, the skeleton does not include any atom which is present as the terminal atom and is not involved in the corresponding bonding chain which links the two amide groups such as hydrogen atoms and fluorine atoms. In this respect, however, if the skeleton includes an atom or atoms constituting a ring (an aromatic ring or an alicyclic ring), all of the atoms constituting the corresponding ring are considered to be included in the foregoing “skeleton”. For instance, when a benzene or cyclohexyl ring is included, the 6 carbon atoms constituting the benzene or cyclohexyl ring are included in the foregoing “skeleton”. In this connection, substituents and hydrogen atoms linked to and present on the benzene or cyclohexyl ring are not included in the “skeleton” herein defined.

For this reason, if a carbonyl group is present in the skeleton, only the carbon atom among those constituting the carbonyl group is involved in the chain connecting the foregoing two amide groups and accordingly, the oxygen atom of the carbonyl group is not considered to be a member of the skeleton. In addition, regarding the 2,2-propylidene and hexafluoro-2,2-propylidene bonds, only the carbon atom existing at the center (2-position) thereof is regarded as a member of the skeleton, while the carbon atoms at the both ends (1-position and 3-position) thereof are not regarded as members of the skeleton. In the present invention, examples of the “atom having an unshared electron pair” include oxygen, nitrogen and sulfur atoms, on the other hand examples of the “atom free of any unshared electron pair” include carbon and silicon atoms.

Preferably, X appearing in the photo-sensitive polyimide precursor (a) represents a group free of any atom having an unshared electron pair in the skeleton thereof. This is because the resulting resin composition is only slightly swollen during the development thereof with an alkali. Likewise, Y preferably represents a group free of any atom having an unshared electron pair in the skeleton thereof, for the same reason.

Moreover, Y present in the repeating units constituting the photo-sensitive polyimide precursor (a) is preferably partially replaced with Y“which contains a silicon atom such as a group containing a siloxane bond since this would result in the considerable improvement of the adhesion of the resulting resin composition to a substrate. In this case, the rate of the replacement is preferably 1 to 20% by mole on the basis of the total molar amount of the diamine residues constituting the photo-sensitive polyimide precursor.

Examples of the groups X and Y appearing in the foregoing general formula (1) preferably include alkyl chains having 4 to 20 carbon atoms, cycloalkyl rings having 4 to 20 carbon atoms such as cyclohexyl rings, aromatic rings having 6 to 20 carbon atoms such as benzene rings and naphthalene rings, and divalent or tetravalent groups derived from those formed by linking 2 to 10 such aromatic rings through single bonds, alkylene groups, fluorinated alkylene groups and/or carbonyl groups. Moreover, these groups may have, on their aromatic rings, substituents such as hydrocarbon groups, halogenated hydrocarbon groups and/or halogen atoms. Among these groups represented by X and Y, preferred are those in which atoms directly bonded to those constituting the skeleton are likewise “atom free of any unshared electron pair” since the intended effect may further be improved (the following are out of this definition, a group in which an oxygen atom is directly bonded to a carbon atom constituting the skeleton such as a carbonyl group and a group in which a fluorine atom is bonded to a carbon atom constituting the skeleton). Moreover, these groups represented by X and Y are preferably those free of any fluorine atom.

Examples of the acidic functional groups included in the molecule of the component (a) are carboxyl groups, phenolic hydroxyl groups and sulfonic acid residues, with carboxyl groups being preferred. In addition, the photo-sensitive groups may preferably be those containing a carbon-carbon unsaturated double bond such as vinyl, allyl, acryloyl, methacryloyl, acryloxy and methacryloxy groups. Among them, more preferably used herein are acryloyl, methacryloyl, acryloxy and methacryloxy groups.

Alternatively, the substituent R or R′ which represents an OH group (in other words, carboxyl group) may serve as the foregoing acidic functional group present in the component (a) or the acidic functional group may likewise present in the diamine residue represented by Y Further, the photo-sensitive group is preferably present in the side chain represented by R or R′ appearing in the foregoing formula or present in the diamine residue represented by Y. For instance, it is preferably present therein as a group bonded to the aromatic ring of an aromatic ring-containing diamine residue.

In the definition of R and R′ of the repeating unit represented by Formula (1), examples of the monovalent organic groups carrying photo-sensitive groups include those represented by the following general formulas: 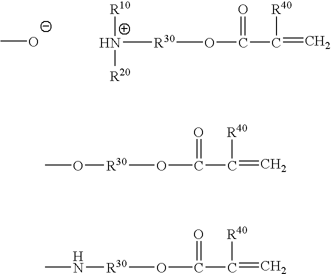
wherein, R¹⁰ and R²⁰ each independently represent a monovalent hydrocarbon group having 1 to 6 carbon atoms, R³⁰ represents a divalent hydrocarbon group having 1 to 10 carbon atoms and R⁴⁰ represents a hydrogen atom or a methyl group. In addition, examples thereof likewise include those free of any photo-sensitive group such as alkoxy groups having 1 to 15 carbon atoms, or alkylamino groups having 1 to 15 carbon atoms. The component (a) having the repeating units represented by the foregoing general formula (1) are preferably those comprising 50 to 100% by mole of the repeating units represented by Formula (1) on the basis of the total amount of the repeating units included in the component. Among them, preferred examples thereof are the components only comprising the repeating units represented by Formula (1) or those comprising the repeating units represented by Formula (1) and the repeating units represented by Formula (1) wherein Y represents a silicon atom-containing divalent organic group.

The photo-sensitive polyimide precursor (a) preferably has a molecular weight ranging from 80,000 to 5,000 as expressed in terms of the weight average molecular weight. The weight average molecular weight can be measured according to the gel permeation chromatography technique and can be expressed in terms of the value relative to that of the standard polystyrene.

The photo-sensitive polyimide precursor (a) can be prepared from a tetracarboxylic acid di-anhydride, a diamine and an optional photo-sensitive group-containing compound as raw materials and various known methods may be used for the preparation thereof. For instance, the precursor may be prepared by a synthetic method which makes use of a polyamic acid as a polycondensate of a tetracarboxylic acid di-anhydride with a diamine and an agent for converting into an iso-imide selected from the group consisting of N,N′-dihydrocarbyl-substituted carbodiimide, trifluoroacetic acid anhydride and mixtures thereof, as disclosed in Japanese Examined Patent Publication (hereunder referred to as “J.P. KOKOKU”) Hei 4-62306.

Among the foregoing tetracarboxylic acid di-anhydrides, examples of those providing the foregoing X include pyromellitic acid di-anhydride, 3,3′,4,4′-biphenyl- tetracarboxylic acid di-anhydride, 1,2,5,6-naphthalene-tetracarboxylic acid di-anhydride, 2,3,6,7-naphthalene-tetracarboxylic acid di-anhydride, 1,4,5,8-naphthalene-tetracarboxylic acid di-anhydride, 3,4,9,10-perylene-tetracarboxylic acid di-anhydride, m-terphenyl-3,3′,4,4′-tetracarboxylic acid di-anhydride, p-ter-phenyl-3,3′,4,4′-tetracarboxylic acid di-anhydride, 4,4′-hexafluoro-isopropylidene di- phthalic acid di-anhydride, and 3,3′,4,4′-benzophenone-tetracarboxylic acid di-anhydride and these di-anhydrides may be used alone or in any combination of at least two of them. Preferably used herein are, for instance, pyromellitic acid di-anhydride and 3,3′,4,4′-biphenyl-tetracarboxylic acid di-anhydride among others.

In addition, examples of diamines, which can provide the foregoing groups Y and preferably used herein, include 2,2′-dimethyl-4,4′c-diaminobiphenyl, 3,3′-di-methyl-4,4′-diaminobiphenyl, 2,2′,6,6′-tetramethyl-4,4′-diaminobiphenyl, 3,3′,5,5′-tetramethyl-4,4′-diamino-biphenyl, 4,4′- (or 3,4′-, 3,3′-, 2,4′- or 2,2′-) diaminoc-diphenyl-methane, p-xylylenediamine, m-xylylene-di-amine, 4,4′-methylene-bis-(2,6-diethylaniline), 4,4′-methylene-bis-(2,6-di-isopropyl-aniline), 1,5′-diamino-naphthalene, 3,3′-dimethyl-4,4′-diamino-diphenylmethane, 3,3′,5,5′-tetramethyl-4,4′-diamino-diphenyl-methane, 2,2-bis-(4-amino-phenyl)propane, 2,2′-hexafluoro-dimethyl-4,4′-diamino-biphenyl, 3,3′-hexafluoro-dimethyl-4,4′-diaminobiphenyl, 4,4′-hexafluoro-iso-propylidene-di-aniline, 1,1,1,3,3,3-hexafluoro-2,2-bis(4-aminophenyl)propane, 2,3,5,6-tetramethyl-1,4-phenylene-diamine, 2,5-dimethyl-1,4-phenylenediamine, 2,4-diaminotoluene, 2,6-diamino-toluene, 2,4,6-trimethyl-1,3-phenylenediamine, 2,7-diaminofluorene, 4,4-diamino-octafluoro-biphenyl, and 2,2-hexafluoro-dimethyl-4,4′-diaminobiphenyl and these diamines may be used alone or in any combination of two or more of them.

Among them, preferably used herein include, for instance, 2,2′-dimethyl-4,4′-diamino-biphenyl, 3,3′-dimethyl-4,4′-diaminobiphenyl, 2,2′,6,6′-tetramethyl-4,4′-di-amino-biphenyl, 3,3′,5,5′-tetramethyl-4,4′-diamino-biphenyl, p-phenylene-diamine, m-phenylene-diamine, 2,4-diamino-mesitylene, 2,3,5,6-tetramethyl-1,4-phenylene-diamine, 2,5c-dimethyl-1,4-phenylenediamine, 2,4-diaminotoluene, 2,6-diaminotoluene and 2,4,6-trimethyl-1,3-phenylenediamine.

Moreover, Y may comprise at least one phenolic hydroxyl group or carboxyl group inasmuch as it is a difunctional amine free of any atom having an unshared electron pair in its skeleton which links amino groups. Examples thereof preferably used herein include 2,5-diaminobenzoic acid, 3,4-diaminobenzoic acid, 3,5-diamino-benzoic acid, 2,5-diamino-terephthalic acid, bis(4-amino-3-carboxyphenyl)methylene, 4,4′-diamino-3,3′-dicarboxy-biphenyl, 4,4′-diamino-5,5′-dicarboxy-2,2′-di-methyl-biphenyl, 1,3-diamino-4-hydroxybenzene, 1,3-diamino-5-hydroxybenzene, 3,3′-diamino-4,4′-dihydroxy-biphenyl, 4,4′-diamino-3,3′-dihydroxy-biphenyl, bis(3-amino-4-hydroxyphenyl)hexafluoro-propane, bis(4-amino-3-hydroxyphenyl)hexa-fluoropropane, bis(4-amino-3-carboxyphenyl)methane, and 4,4′-diamino-2,2′-di-carboxy-biphenyl. These difunctional amines may be used alone or in any combination of at least two of them together with the foregoing diamine. Preferably used herein include, for instance, 2,5-diaminobenzoic acid, 3,5-diamino-benzoic acid, 2,5-diamino-terephthalic acid, 4,4′-diamino-3,3′-dicarboxy-biphenyl, and 4,4′-di-amino-5,5′-dicarboxy-2,2′-dimethyl-biphenyl, among others.

Furthermore, examples of the diamines each providing Y′ which contains a silicon atom or silicone atoms include aliphatic diamines such as diamino-polysiloxanes represented by the following general formula (2): 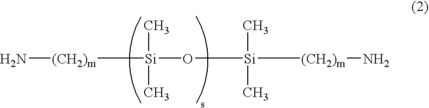
wherein, m and n each independently represent an integer ranging from 1 to 10, and s represents an integer ranging from 1 to 10. When using this aliphatic diamine, the amount thereof to be added is preferably not more than 20% by mole on the basis of the total amount of the diamine since the resulting resin composition only slightly gets swollen upon its development and from the viewpoint of, for instance, the heat resistance among the physical properties of the resulting film. In addition to the foregoing, it is also possible to use a tetracarboxylic acid anhydride or a diamine which can provide a residue other than the foregoing residue X or Y, in such an amount that the use thereof never adversely affects the intended effects of the present invention.

The polyimide precursor may be converted into its derivative carrying a photo-sensitive group by, for instance, a method which comprises the step of converting a compound having a carbon-carbon unsaturated double bond and an amino group or a group derived from the quaternary salt thereof into a derivative or a polyimide precursor in which the carboxyl groups of the polyamide acid are linked to the amino group or the group derived from the quaternary salt thereof through ionic bonds; or a method for introducing carbon-carbon unsaturated double bonds into side chains of the polyimide precursor through covalent bonds such as ester bonds or amide bonds.

Among them, those particularly suitable for the alkaline development are photo-sensitive polyimide precursors (polyamide acid esters) which have carbon-carbon unsaturated double bonds introduced into the same through ester bonds. When introducing the carbon-carbon unsaturated double bonds into the precursor through ester bonds, the amount of the compound carrying such a carbon-carbon unsaturated double bond to be introduced preferably ranges from 85 to 25% by mole on the basis of the total amount of the carboxyl groups present in the polyamide acid and the balance of the un-reacted carboxyl groups (i.e., partial ester of polyamide acid) in order to make a compromise between properties such as the solubility in an alkali, the curability through light-exposure and heat resistance and the reactivity.

The following are specific examples of the compounds used for the introduction of such carbon-carbon unsaturated double bonds into the precursors through ester bonds: 2-hydroxyethyl acrylate, 3-hydroxypropyl acrylate, 2-hydroxy-ethyl methacrylate, 3-hydroxypropyl methacrylate, 4-hydroxybutyl acrylate, 4-hydroxybutyl methacrylate, pentaerythritol diacrylate monostearate, penta-erythritol triacrylate, pentaerythritol tri-methacrylate, caprolactone 2-(meth-acryloyloxy) ethyl ester, di-caprolactone 2-(methacryloyloxy)ethyl ester, caprolactone 2-(acryloyloxy)ethyl ester and di-caprolactone 2-(acryloyloxy)ethyl ester.

The negative-type photo-sensitive polyimide composition further comprises a sensitizer (b). Examples of such sensitizers are photopolymerization initiators or sensitizers, for instance, benzophenones such as benzophenone, Michler's ketone, 4,4-bis(diethylamino) benzophenone, and 3,3,4,4-tetra-(t-butyl peroxycarbonyl)benzophenone; benzylidenes such as 3,5-bis(diethylamino-benzylidene)-N-methyl-4-piperidone and 3,5-bis(diethylamino-benzylidene)-N-ethyl-4-piperidone; coumarins such as 7-diethylamino-3-thenoyl-coumarin, 4,6-di-methyl-3-ethylamino-coumarin, 3,3-carbonyl-bis(7-diethylamino-coumarin), 7-di-ethyl-amino-3-(1-methyl-methylbenzimidazolyl)coumarin and 3-(2-benzo-thiazolyl)-7-di-ethylamino-coumarin; anthraquinones such as 2-t-butyl-anthraquinone, 2-ethyl-anthraquinone and 1,2-benzanthraquinone; benzoins such as benzoin methyl ether, benzoin ethyl ether and benzoin isopropyl ether; thioxanthones such as 2,4-di-methyl-thioxanthone, 2,4-diethyl-thioxanthone, 2,4-di-isopropyl-thioxanthone and 2-isopropyl-thioxanthone; mercaptans such as ethylene glycol di(3-mercapto-propionate), 2-mercapto-benzothiazole, 2-mercapto-benzoxazole and 2-mercapto-benzimidazole; glycines such as N-phenyl glycine, N-methyl-N-phenyl glycine, N-ethyl-N-(p-chlorophenyl)glycine and N-(4-ciano-phenyl)glycine; oximes such as 1-phenyl-1,2-butanedione-2-(o-methoxycarbonyl)oxime, 1-phenyl-1,2-propane-dione-2-(o-methoxycarbonyl)oxime, 1-phenyl-1,2-propanedione-2-(o-ethoxy-carbonyl)oxime and 1-phenyl-1,2-propanedione-2-(o-benzoyl)oxime; and 2,2′-bis(o-chloro-phenyl)-4,4′,5,5′-tetraphenyl-biimidazole. The foregoing sensitizers may be used alone or in any combination of at least two of them.

Among these sensitizers, a combination of sensitizers selected from benzophenones, glycines, mercaptans, oximes and 2,2′-bis(o-chlorophenyl)-4,4′,5,5′-tetraphenyl-biimidazole listed above is preferably used in the present invention from the viewpoint of their ability of undergoing photolytic reactions.

These sensitizers may be used alone or in any combination of at least two of them. The amount of the sensitizer to be used preferably ranges from 0.01 to 40 parts by weight per 100 parts by weight of the polyimide precursor as the component (a) in view of the reactivity and other characteristic properties of the sensitizers. In general, the amount thereof ranges from 0.01 to 15 parts by weight for a single sensitizer and 0.01 to 40 parts by weight in total when they are used in combination.

The component (c) or the silicon atom-containing compound having a reactive unsaturated functional group and an alkoxy group or an acyloxy group possesses a function as an auxiliary agent for adhesion, but it is important to use this compound since the use of this compound among a variety of silicon atom-containing compounds would permit the formation of a negative-type photo-sensitive resin composition excellent in the adhesion to a substrate and the shape of the resulting pattern.

In this respect, the “reactive unsaturated functional group” used herein means, for instance, a reactive carbon-carbon unsaturated double bond and a reactive carbon-carbon unsaturated triple bond, which are usually handled as one united substituent and examples thereof include vinyl, isopropenyl, allyl, acryloxy, methacryloxy, acryloyl, methacryloyl, vinylidene, vinylene, ethynyl and propargyl groups. Among them, preferably used herein are vinyl, acryloxy and methacryloxy groups in the light of the reactivity thereof. In addition, the number of the functional groups included in the component (c) preferably ranges from 1 to 4. In this respect, if two or more functional groups are present, they may be identical to or different from one another.

The alkoxy group may be, for instance, one having 1 to 5 carbon atoms and the acyloxy group may be one having 1 to 5 carbon atoms, but preferably used herein include, for instance, methoxy, ethoxy and acetoxy groups while taking into consideration the reactivity thereof. Specific examples of the components (c) include di-ethoxymethyl vinyl silane, tri-acetoxy vinyl silane, triethoxy vinyl silane, butenyl triethoxy silane, allyl trimethoxy silane, allyl dimethoxy silane, allyl triethoxy silane, 3-allylthio-propyl trimethoxy silane, 7-octenyl trimethoxy silane, N-3-(acryloxy-2-hydroxypropyl)-3-aminopropyl triethoxy silane, styrylethyl trimethoxy silane, vinylphenyl diethoxy silane, 3-allylaminopropyl trimethoxy silane, methacryloxy-methyl trimethoxy silane, methacryloxy-methyl triethoxy silane, 3-methacryloxy-propyl dimethoxy-methyl silane, 3-acryloxy-propyl trimethoxy silane, 3-methacryloxy-propyl trimethoxy silane, 3-methacryloxy-propyl triethoxy silane, tri-isopropoxy vinyl silane, tris(2-methoxyethyl) vinyl silane, 6-triethoxysilyl-2-norbornene, (2-(3-cyclohexenyl)ethyl)trimethoxy silane, and (2-(3-cyclohexenyl)ethyl)triethoxy silane. These compounds may be used alone or in any combination of two or more of them.

Among them, preferably used herein are those, in which the reactive unsaturated functional group thereof is a covalent double bond-containing one such as a vinyl, methacryloyl or acryloyl group, and specific examples thereof are styryl-ethyl trimethoxy silane, N-3-(acryloxy-2-hydroxypropyl)-3-aminopropyl triethoxy-silane, 3-allylaminopropyl trimethoxysilane, methacryloxy-methyl trimethoxy-silane, methacryloxy-methyl triethoxysilane, 3-methacryloxypropyl dimethoxy-methylsilane, 3-acryloxypropyl trimethoxysilane, 3-methacryloxypropyl trimethoxysilane, and 3-methacryloxypropyl triethoxysilane, because of their high reactivity. These compounds may be used alone or in any combination of two or more of them.

The amount of the compound used as the component (c) to be incorporated into the resin composition preferably ranges from 0.1 to 30 parts by weight per 100 parts by weight of the polyimide precursor as the component (a). If the amount thereof to be used is less than 0.1 part by weight, the resulting film is liable to be easily peeled off upon its development, while if it exceeds 30 parts by weight, the resulting composition often forms a suspension or the resulting film undergoes whitening since the compatibility of the component (c) in the composition is low.

Further, the negative-type photo-sensitive polyimide composition may comprise an addition-polymerizable compound having, for instance, vinyl, isopropenyl, allyl, acryloxy, methacryloxy, acryloyl, methacryloyl, vinylidene, vinylene, ethynyl and/or propargyl groups. Specific examples thereof are diethylene glycol diacrylate, triethylene glycol diacrylate, tetraethylene glycol diacrylate, diethylene glycol dimethacrylate, triethylene glycol dimethacrylate, tetraethylene glycol dimethacrylate, 1,4-butanediol diacrylate, 1,4-butanediol dimethacrylate, 1,6-hexanediol diacrylate, 1,6-hexanediol dimethacrylate, 1,9-nonanediol dimethacrylate, pentaerythritol triacrylate, pentaerythritol tetra-acrylate, pentaerythritol trimethacrylate and pentaerythritol tetra-methacrylate. These compounds may be used alone or in any combination of two or more of them. The amount of the foregoing component to be incorporated into the resin composition preferably ranges from 5 to 100 parts by weight per 100 parts by weight of the polyimide precursor as the component (a) and the amount thereof more preferably ranges from 5 to 40 parts by weight while taking into consideration the compatibility thereof in the composition. This is because, if the amount thereof to be used is less than 5 parts by weight, the exposed area of the resulting film is dissolved out during its development and there is a tendency such that any film never remains after the development. On the other hand, if it exceeds 100 parts by weight, there is likewise a tendency such that any film never remains after the development and when a solution thereof is used for forming a film, the resulting film sometimes undergoes whitening.

In addition, the negative-type photo-sensitive polyimide composition may comprise a radical polymerization inhibitor or a radical polymerization retarder for the improvement of the storage stability of the resin composition. Examples of such radical polymerization inhibitors or retarders are p-methoxy phenol, diphenyl-p-benzoquinone, benzoquinone, hydroquinone, pyrogallol, phenothiazine, resorcinol, o-dinitrobenzene, p-dinitrobenzene, m-dinitrobenzene, phenanthraquinone, N-phenyl-1-naphthylamine, N-phenyl-2-naphthylamine, cupferron, phenothiazine, 2,5-toluquinone, tannic acid, p-benzylamino phenol, and nitrosamines. These compounds may be used alone or in any combination of two or more of them. When using a radical polymerization inhibitor or a radical polymerization retarder, it is common that the amount thereof to be used preferably ranges from 0.01 to 30 parts by weight per 100 parts by weight of the polyimide precursor as the component (a).

The negative-type photo-sensitive polyimide composition may further comprise other additives which have been known as the additives usable for the photo-sensitive resin composition such as a plasticizer, and/or adhesion accelerator. The photo-sensitive resin composition is in general produced by dissolving in an organic solvent. In this respect, the organic solvent preferably used herein is in general a polar solvent capable of completely dissolving the resulting polyimide and specific examples thereof include N-methyl-2-pyrrolidone, N,N-dimethyl-acetamide, N,N-dimethylformamide, dimethylsulfoxide, tetramethyl urea, hexamethyl phosphoric acid triamide and y -butyrolactone. The amount of the solvent used is such that the NV value of the resulting solution is not less than 35%.

(Preparation of Filling Polymer)

The coating solution for forming a filling polymer layer is applied onto the surface of a substrate according to any conventionally known method such as the bar coater-coating technique or the spin-coating technique. The amount thereof to be coated may appropriately be selected depending on the size of the substrate and the depth of the V-shaped groove. After the application of the foling polymer-forming (or containing) coating solution, the solvent present in the coating solution is removed through drying. Upon drying, the coated solution is preferably baked at a temperature ranging from 60 to 100° C. for about 2 to 4 minutes in order to prevent the adhesion of any foreign substance and to eliminate the solvent fraction.

After the application of the filling polymer-forming coating solution and the subsequent drying of the same, the unnecessary portion of the fdljig polymer film except for that present in the V-shaped groove is removed. At this stage, it is preferred to leave the filling polymer at the peripheral area of the V-shaped groove on the substrate in the form of a picture frame-like shape (for instance, a shape enclosing the V-shaped groove at a width ranging from about 2 to 20,u m; hereunder also referred to as a “picture frame(-like) structure”). This is because, the presence of the fdiing polymer on the substrate in such a picture frame-like shape would permit the prevention of any penetration of an optical waveguide-forming polymer into the V-shaped groove upon the formation of the waveguide and as a result, the presence thereof would make the removal of the unnecessary filling polymer quite easy. The height of the foregoing picture frame-like structure from the surface of the substrate (the height up to the highest level thereof) preferably ranges from 5 to 20 μm. If it is not more than 5 μm, the thickness thereof at the edge of the V-shaped groove is too thin, some areas are not completely covered with the polymer and it is thus difficult to inhibit the penetration of the optical waveguide-forming polymer into the V-shaped groove.

If using a means such as the ultrasonic cleaning or the high pressure cleaning technique, the foregoing effect can further be improved.

When the fling polymer is a photo-sensitive polymer such as a photo-sensitive polyimide, the film thereof is exposed to light rays through a mask carrying a desired pattern and then developed to thus easily remove the unnecessary portions thereof. The exposure may be carried out using, for instance, ultraviolet rays, visible light rays, X-rays, or an electron beam. Examples of exposure devices include high pressure mercury lamps.

After the light-exposure, the exposed area for the positive-type photo-sensitive polymer or the un-exposed area for the negative-type photo-sensitive polymer is removed by the dissolution thereof through the development with a developer to thus give a desired pattern. The developer preferably used herein is an alkaline developer, for instance, an aqueous solution of triethanolamine, sodium hydroxide, potassium hydroxide, sodium silicate or tetramethyl ammonium hydroxide having a concentration of not more than 5% by weight and preferably such an aqueous solution having a concentration ranging from 1.5 to 3.0% by weight. The developer more preferably used herein is an aqueous solution of tetramethyl ammonium hydroxide having a concentration ranging from 1.5 to 3.0% by weight and the most preferably used developer is an aqueous solution of tetramethyl ammonium hydroxide having a concentration of 2.38% by weight. Moreover, the foregoing developer may likewise be used after the incorporation of an alcohol and/or a surfactant into the same. After the completion of the development, the resulting developed product is if necessary rinsed with water or a poor solvent.

The pattern thus obtained is then cured to thus give a stable high heat-resistant polyimide pattern from which the photo-sensitive agent and the solvent are completely removed.

The curing step is preferably carried out at a temperature higher than the Tg of the filling polymer used. When the V-shaped groove is filled with at least two filling polymer layers, as will be described later, the curing step is preferably carried out at a temperature higher than the Tg of the lowermost filling polymer layer. This is because, if the curing step is carried out at such a temperature, the filing polymer can ultimately and efficiently be removed from the V-shaped groove.

The curing temperature is preferably set at a level of not less than 250° C. and more preferably 250 to 500° C., inasmuch as the foregoing requirements are satisfied. More specifically, the curing temperature is preferably not less than 350° C. for the positive-type photo-sensitive polymer and not less than 250° C for the negative-type photo-sensitive polymer.

At this stage, the heating time preferably ranges from 0.05 to 10 hours. If the heating time is less than 0.05 hour, the resulting polyimide film has a tendency such that it has reduced mechanical characteristics and thermal properties, while if it exceeds 10 hours, the resulting polyimide film is likewise liable to have reduced mechanical characteristics and thermal properties.

After the formation of the first filling polymer layer, a second filling polymer layer is if necessary formed by the same method. More specifically, the first and second filling polymer layers can likewise be prepared by repeating the following sub-steps at least two times using the required number of filling polymer-coating solutions each having an NV value of not less than 35%, in the step (2) of the method according to the first embodiment of the present invention: a sub-step of applying each filling polymer-coating solution; a sub-step of drying the applied layer; and a sub-step of removing the unnecessary portion of the coated layer. The second filling polymer layer may optionally be formed while taking into consideration the NV value and other properties of the first filling polymer. Further, the second filling polymer may be identical to or different from the first filling polymer. The first filling polymer will play a role as a peelable layer and therefore, the polymer is preferably selected while taking into consideration the peeling ability thereof.

After the application of the layer constituted by a photo-sensitive resin composition on a substrate as has been described above, a polymeric optical waveguide such as that discussed above is formed on the layer. The method for forming the optical waveguide is not restricted to any specific one, but the waveguide may be, for instance, formed by a method which comprises the steps of forming a lower clad layer, then forming a core layer, processing the core layer, by a method such as the etching technique, into a pattern of a desired optical waveguide to thus form a core and finally forming an upper clad layer.

After the formation of such a polymeric optical waveguide, the optical waveguide-forming polymer layer is cut at the boundary between the optical waveguide portion and the V-shaped groove by, for instance, dicing for the removal of the waveguide-forming polymer layer formed even on the V-shaped groove. At this stage, it is preferred to cut the polymer layer extending from the end of the optical waveguide to the end face of the V-shaped groove and the polymer layer present at the periphery of the groove and to thus remove the unnecessary portion of the polymer layer.

The filling polymer remaining in the V-shaped groove and the optical waveguide-forming polymer layer remaining on the V-shaped groove are removed after the formation of the optical waveguide. They can be removed by a means. such as the application of ultrasonics, the boiling technique, the removal with a resist-peeling solution such as a mixed solution of di-propylene glycol monomethyl ether and mono-isopropanolamine, the technique using a 15% TMAH aqueous solution, and any combination of these techniques, but the present invention is not restricted to these specific examples at all.

(Method for Preparing Optical Waveguide Device)

One embodiment of the method for preparing the optical waveguide device according to the present invention will now be described in detail below while taking more specific procedures by way of example with reference to the attached FIGS. 1 and 2.

For instance, a silicon wafer 1 having a diameter of 76 mm is provided as a substrate. V-shaped grooves 2 are formed on the substrate 1 (see FIG. 1 and FIG. 2A). These V-shaped grooves can be formed by any means such as the anisotropic etching technique using, for instance, a 35% aqueous solution of potassium hydroxide.

A coating solution of a positive-type photo-sensitive polymer composition having an NV value of not less than 35% (a filing polymer-coating solution) is applied onto the substrate 1 and the V-shaped grooves 2 using a bar coater. After the application of the coating solution, the coated layer thereof is heated, for instance, at 100° C. for 5 minutes and then dried (FIG. 2B).

Amask carrying a pattern of the V-shaped grooves is put on the layer of the foregoing positive-type photo-sensitive polymer composition and then exposed to light rays. In this connection, the shape of the mask may be one which can provide picture frame-like structure having a width ranging from 2 to 20 μm at the peripheral portions of the V-shaped grooves. After the light-exposure, the photo-sensitive polymer layer is developed with a developer to thus remove the exposed area (FIG. 2C). After the development, the filling polymer is if necessary cured by, for instance, heating to a temperature ranging from 300 to 350° C.

The height or depth (h) of the surface of the filling polymer 4 (the position farthest from the substrate surface) in the resulting V-shaped grooves from the surface of the substrate (or the distance between the surface of the polymer 4 and the surface of the substrate) is preferably not more than 20 μm, more preferably not more than 15 μm and most preferably not more than 10 μm to ensure the achievement of the effects of the present invention. In this respect, the surface of the filling polymer may be lower than the surface of the substrate or the both lower and upper positions of the substrate surface (FIG. 2C). In other words, the surface of the filling polymer may be projected from the substrate surface here and there or may be depressed, in places, relative to the substrate surface.

Moreover, when the filling polymer layer has a picture frame-like structure, the vertical distance (h′) between the substrate surface and the highest portion of the picture frame-like structure preferably ranges from 5 to 20 μm.

In this connection, when forming the V-shaped grooves by the anisotropic etching technique, the substrate is preferably cut off, between the V-shaped groove and the optical waveguide, at a width ranging from about 100 to 200 μm, for instance, about 150 μm and such a cutting off step would also permit the removal of a part of the sagging and running portions of the optical waveguide. Accordingly, in such cases, the intended effects of the present invention can be achieved inasmuch as the height of the filling polymer 4 from the substrate surface falls within the range specified above although the surface of the filling polymer 4 is not in complete agreement with the surface of the substrate.

Then a PIQ coupler layer 5 serving as an adhesive layer for the optical waveguide polymer is if necessary formed (FIG. 2F). Subsequently, a clad layer and a core are formed using fluorinated polyimide resins according to any conventionally known method to thus give an optical waveguide 6 (FIGS. 2G-1, G-2).

After the formation of the optical waveguide 6, a cutting mark is formed in the optical waveguide at its end position (at the boundary between the zone carrying the V-shaped grooves and the optical waveguide zone) for the removal of the unnecessary portion of the material for the optical waveguide. In this respect, the cutting mark can appropriately be formed by any means such as the dicing or dry etching technique. At this stage, it is likewise preferred to cut off even the polymer layer extending from the end position of the optical waveguide to the edge portion of the V-shaped groove and the polymer layer present at the periphery of the groove and to thus remove the unnecessary portion thereof for the effective removal of the polymer within the V-shaped groove in the final step (FIGS. 2H-1, H-2).

Thus, the polymer present in and on the V-shaped grooves is completely removed (FIGS. 2I-1, I-2). The polymer present in the V-shaped grooves can be removed by appropriately combining, for instance, a heat-treatment and the application of ultrasonics.

The end of the V-shaped groove is cut off at a constant width (for instance, about 150 μm wide) by dicing (FIG. 2J-2).

Each optical waveguide device is cut out from the resulting wafer to thus obtain a large number of polymeric optical waveguide devices.

An embodiment of the method for preparing an optical waveguide device according to the present invention, in which the filling polymer layer comprises at least two layers will be described in detail below with reference to FIG. 3.

V-Shaped grooves 20 are formed on a substrate 10 (FIG. 3A). The means for forming such V-shaped grooves 20 are the same as those described above in connection with the formation of the V-shaped grooves 2.

A coating solution (a filling polymer-containing (or forming) coating solution) of a positive-type photo-sensitive polymer composition having an NV value of not less than 35% is applied onto the substrate 10 and the V-shaped grooves 20 using a bar coater. After the completion of the coating, the resulting layer is dried by, for instance, heating at 100° C. for 5 minutes (FIG. 3B).

A mask having a pattern of V-shaped grooves is put on the foregoing layer of the positive-type photo-sensitive polymer composition and the layer is exposed to light through the mask. After the exposure, the exposed layer is developed with a developer to thus remove the exposed area of the layer (FIG. 3C). After the development, the filling polymer is if necessary cured by, for instance, heating the same to a temperature ranging from 300 to 350° C.

When forming two layers of such a Sling polymer, it would be sufficient that the depth (d) of the surface of the first filling polymer layer in the V-shaped groove or the surface of the polymer 40 as shown in FIG. 3C from the substrate surface (FIG. 3C) is about 30 to 60% of the depth D of the V-shaped groove (the distance between the substrate surface and the lowest position of the V-shaped groove). More specifically, it is sufficient that the depth d ranges from about 30 to 60 μm for the V-shaped groove having a depth of 100 μm.

A coating solution (a coating solution containing a filing polymer) of a positive-type photo-sensitive polymer composition having an NV value of not less than 40% is then applied onto the filling polymer 40 using a bar coater. After the completion of the coating, the resulting layer is dried by, for instance, heating at 100° C. for 5 minutes (FIG. 3D).

A mask having a pattern carrying V-shaped grooves provided with picture frame-like structures is put on the foregoing layer of the positive-type photo-sensitive polymer composition and the layer is exposed to light through the mask. After the exposure, the exposed layer is developed with a developer to remove the exposed area of the layer and to thus form a filling polymer layer 41 (FIG. 3E). After the completion of the development, the filling polymer layer 41 is, if necessary, cured by, for instance, heating the same to a temperature ranging from 300 to 350° C.

The height or depth (h) of the surface of the upper layer of the filling polymer in the V-shaped groove or the surface of the filling polymer 41 shown in FIG. 3E from the surface of the substrate is preferably not more than 20 μm, more preferably not more than 151 μm and most preferably not more than 10 μm to ensure the achievement of the effects of the present invention. Moreover, the vertical distance (h′) between the substrate surface and the highest portion of the picture frame-like structure preferably ranges from 5 to 20 μm.

Then a PIQ coupler layer 50 serving as an adhesive layer for the optical waveguide polymer is if necessary formed (FIG. 3F). Next, a clad layer and a core are formed using a fluorinated polyimide resin according to any conventionally known method to thus give an optical waveguides 61, 62 (FIGS. 3G-1, G-2).

After the formation of the optical waveguide, a cutting mark is formed in the optical waveguide at its end position (at the boundary between the zone carrying the V-shaped grooves and the optical waveguide zone) for the removal of the unnecessary portion of the material for the optical waveguide. In this respect, the cutting mark can appropriately be formed by any means such as the dicing or dry etching technique. At this stage, it is likewise preferred to cut off even the polymer layer extending from the end position of the optical waveguide to the edge portion of the V-shaped groove and the polymer layer present at the periphery of the groove and to thus remove the unnecessary portion thereof for the effective removal of the polymer within the V-shaped groove in the final step (FIGS. 3H-1, H-2).

Thus, the polymer present in and on the V-shaped grooves is completely removed (FIGS. 3I-1, I-2). The polymer present in the V-shaped grooves can be removed by appropriately combining, for instance, a heat-treatment and the application of ultrasonics.

Each optical waveguide device is cut out from the resulting wafer to thus obtain a large number of polymeric optical waveguide devices.

### EXAMPLES

The present invention will now be described in more detail with reference to the following Examples.

### Preparation Example 1

To a 0.5 L volume flask equipped with a stirring machine, a thermometer and a Zimm funnel condenser, there were added 17.45 kg of pyromellitic acid dianhydride and 59.30 g of n-butyl alcohol and these components were reacted at 95° C. for 5 hours with stirring. The excess n-butyl alcohol was distilled off under reduced pressure to thus give pyromellitic acid di-n-butyl ester. Then 95.17 g of thionyl chloride and 70.00 g of toluene were introduced into the flask and they were reacted at 40° C. for 3 hours. The excess amounts of thionyl chloride and toluene were removed through the azeotropic distillation under reduced pressure. N-Methyl pyrrolidone (186 g) was added to the reaction system to thus obtain a solution (γ) of pyromellitic acid di-n-butyl ester dichloride.

Then, to a 0.5 L volume flask equipped with a stirring machine, a thermometer and a Zimm funnel condenser, there was added 95 g of N-methyl pyrrolidone, followed by the addition, to the flask, 23.44 g of bis(3-amino-4-hydroxy- phenyl) hexafluoro-propane and 3.97 g of 4,4′-diaminodiphenyl sulfone; stirring the resulting mixture to thus dissolve these added components; addition of 12.66 g of pyridine; dropwise addition of the solution (γ) of pyromellitic acid di-n-butyl ester dichloride over one hour while maintaining the temperature of the content of the flask; and continuous stirring of the mixture over one hour. The resulting solution was poured into 4 L of water, the resulting precipitates were recovered, washed with water and dried under reduced pressure to thus obtain polyamide acid n-butyl ester. The resulting product was inspected for the weight average molecular weight by the GPC technique and found to be 19,200 as expressed in terms of the value relative to that of the polystyrene. There were dissolved, with stirring, 30.00 g of a polyamide acid n-butyl ester and 6.00 g of a compound prepared by reacting tris(4-hydroxyphenyl) methane with naphthoquinone-1,2-diazide-5-sulfonyl chloride in a molar ratio of 1/2.5, in 54.00 g of N-methyl pyrrolidone. The resulting solution was filtered under pressure through a Teflon (registered trade mark) having a pore size of 3 μm to thus give a solution of a positive-type photo-sensitive polymer composition (NV=36%; Tg=300° C.).

### Preparation Example 2

To a stirred solution of pyromellitic acid dianhydride (15.27 g; 0.070M) in dry N-methyl pyrrolidone (100 mL), there was added 1.30 g (0.010 M) of 2-hydroxyethyl methacrylate in a dry nitrogen gas stream. The resulting solution was stirred at room temperature for one hour and then at 35° C. for one hour and then cooled down to room temperature. This reaction solution was dropwise added, over one hour, to a stirred solution of 3,3′-dimethyl-4,4′-diaminodiphenyl (8.49 g; 0.040 M) and 1,3-bis-(3-aminopropyl)tetramethyl di-siloxane (0.25 g; 0.001 M) in 100 mL of dry N-methyl pyrrolidone and then the resulting mixture was stirred at room temperature overnight. Thereafter, a solution of N,N-dicyclohexyl carbodiimide (26.82 g; 0.130 M) in 100 mL of dry N-methyl pyrrolidone was dropwise added, over 30 minutes, to the resulting reaction solution with stirring. To this reaction solution, there was added 45.55 g (0.35 M) of 2-hydroxyethyl methacrylate and the resulting mixture was stirred at 50° C. for 5 hours and then at room temperature overnight. This reaction mixture was diluted with 50 mL of acetone, filtered under reduced pressure to thus give a filtrate free of any insoluble substance and then the resulting filtrate was treated with 2.0 L of ion-exchanged water while vigorously stirring the resulting mixture. The separated solid matter was further washed with ion-exchanged water and then with methanol, dried on a filter under reduced pressure and then dried at room temperature under reduced pressure till the moisture content of the solid matter was reduced to a level of less than 1.0% by weight. A polyamide precursor was thus prepared.

To a 3-necked flask equipped with a stirring machine, a thermometer and a nitrogen gas-introducing tube, there were added 35.0 g of the resulting photo-sensitive polyimide precursor, 50.0 g of N-methyl pyrrolidone and 0.1 g (0.08 mM) of p-methoxy-phenol, the resulting mixture was stirred to thus mix these components and dissolve them in the solvent, there were then added, to the resulting solution, 2.0 g (0.03 mM) of 2,2′-bis(o-chlorophenyl)-4,4′,5,5′-tetraphenyl bi-imidazole, 1.0 g (0.66 mM) of 2-mercapto-benzoxazole, and 0.2 g (0.06 mM) of ethyl Michler's ketone as sensitizers, as well as 3.0 g (10 mM) of triethylene glycol diacrylate and 3.0 g (10 mM) of 1,9-nonanediol diacrylate as addition polymerizable compounds and 1.0 g of 3-methacryloxypropyl trimethoxysilane as an auxiliary agent for adhesion, the resulting mixture was stirred at room temperature overnight to thus dissolve the components and finally the resulting solution was filtered through a filter to thus prepare a solution of a negative-type photo-sensitive polymer composition (having an NV value of 40% and Tg of 300° C.).

### Example 1

A silicon wafer having a diameter of 76 mm was provided as a substrate 10. The steps such as those for forming a film and for patterning were carried out at a time for the overall surface of the wafer-like substrate 10 and the wafer was ultimately cut into individual devices.

(1) Step for Forming V-Shaped Grooves

V-Shaped grooves 20 each having a depth of about 100 m and a width of about 140,u m were formed on the surface of the silicon substrate 10 according to the anisotropic etching technique using a 35% potassium hydroxide aqueous solution warmed at 40° C. (FIG. 3A).

(2) Steps for Coating Filling Polymers 40, 41 and for Removing Unnecessary Portion

The solution of the positive-type photo-sensitive polymer composition (NV=36%) prepared in Preparation Example 1 was coated on the silicon substrate 30 on which the V-shaped grooves had been formed at a speed of rotation of 2000 rpm×30s according to the spin-coating technique. Thereafter the coated layer of the solution was dried by heating the same at 100° C. for 5 minutes (FIG. 3B).

A mask having the pattern of the V-shaped grooves was put on the foregoing layer of the positive-type photo-sensitive polymer composition and the layer was exposed to light through the mask under a condition of 200 mJ/cm². After the exposure, the exposed layer was developed with an aqueous solution of tetramethyl ammonium hydroxide (2.38%) for 100 seconds and then washed with water. Then it was cured by heating at 390° C. for 2 hours to thus form a desired filling polymer layer 40 (FIG. 3C). At this stage, the vertical distance between the surface of the resulting filling polymer layer 40 and the substrate surface (depth (d)) was found to be 30 μm.

The solution of the negative-type photo-sensitive polymer composition (NV=40%) prepared in Preparation Example 2 was applied onto the filling polymer layer 40 at a speed of rotation of 2000 rpm×30s according to the spin- coating technique. Thereafter the coated layer of the solution was dried by heating the same at 100° C. for 5 minutes (FIG. 3D).

A mask having the pattern corresponding to the V-shaped grooves was put on the foregoing layer of the negative-type photo-sensitive polymer composition and the layer was exposed to light through the mask under a condition of 150 mJ/cm² and then subjected to a post-heating treatment at 115° C. for 5 minutes. In this connection, the mask used had such a shape that the filling polymer having a picture frame-like structure remained on the periphery of each V-shaped groove. After the exposure, the exposed layer was developed with an aqueous solution of tetramethyl ammonium hydroxide (2.38%) for 100 seconds and then washed with water. Then it was cured by heating at 390° C. for 2 hours to thus form a desired filling polymer layer 41 (FIG. 3E). At this stage, the vertical distance (height or depth (d)) between the surface of the resulting filling polymer layer 41 and the substrate surface was found to be in the range of from 10 to 15 μm (falling within the range of from the minimum to the maximum of the values of h observed for the elements within the wafer). In addition, the height h′ of the picture frame structure from the substrate surface was found to be 6 μm.

(3) Step for Forming Optical Waveguide 60

A polyimide resin free of any fluorine atom (available from Hitachi Chemical Du-Pont Microsystems Company under the trade name of PIQ13) as an adhesive for the optical waveguide was applied onto the substrate 10 at a speed of rotation of 1000 rpm×30s according to the spin-coating technique. After the completion of the coating, the coated layer thereof was cured by heating the same at 60° C. for 5 minutes to thus give an adhesive layer 50 having a thickness of 0.23 μm (FIG. 3F).

A fluorine atom-containing polyimide resin (available from Hitachi Chemical Co., Ltd. under the trade name of OPI-N1005) was spin coated on the whole upper surface of the silicon substrate 10 using a whirler to thus form a film of a solution of the material therefor. Subsequently, the solvent was evaporated by heating the layer at 100° C. for 30 minutes and then 200° C. for 30 minutes using a dryer and then the resin was cured by heating the layer at 370° C. for 60 minutes to thus obtain a lower clad having a thickness of 5.78 μm.

A fluorine atom-containing polyimide resin (available from Hitachi Chemical Co., Ltd. under the trade name of OPI-N3205) was spin-coated on the lower clad at a speed of rotation of 2000 rpm×30 sec using a whirler to thus form a film of a solution of the material therefor. Subsequently, the solvent was evaporated by heating the layer at 100° C. for 30 minutes and then 200° C. for 30 minutes using a dryer and then the resin was cured by heating the layer at 350° C. for 60 minutes to thus obtain a polyimide film having a thickness of 6.5 μm and serving as a core layer.

A resist was applied onto the core layer using a spin coater, followed by drying of the coated resist layer, exposure of the same to light rays and the subsequent development to thus form a resist layer having a desired pattern (a patterned resist layer). This patterned resist layer was used as a mask for processing or patterning the core layer to thus form a core having a desired shape. More specifically, the core layer was subjected to a reactive ion etching treatment with oxygen (O₂-RIE) through the patterned resist layer as a mask to thus obtain a core 61.

A fluorine atom-containing polyimide resin (available from Hitachi Chemical Co., Ltd. under the trade name of OPI-N1005) was spin-coated on the whole upper surface of the silicon substrate 1 using a whirler and then the solvent was evaporated by heating the coated layer at 100° C. for 30 minutes and then 200° C. for 30 minutes using a dryer and further the resin was cured by heating the layer at 370° C. for 60 minutes to thus obtain an upper clad having a thickness of 10 μm (FIGS. 3G-1, G-2).

(4) Scribed Mark-Formation

Scribed marks were formed using a resist (specific material therefor was a silicon-containing resist available from FUJI Arch Company under the trade name of FH-3CS) according to the spin-coating technique (about 4 μm at a speed of rotation of 600 rpm×30 sec).

The resist layer was exposed to light rays through a mask and then developed (with TMAH for 180 seconds) to thus form a desired resist pattern.

The polymer portion, on which any resist pattern was not present at all and which was accordingly exposed, was removed by etching through the dry etching technique till the substrate surface was exposed (FIGS. 3H-1, H-2).

(5) Step for Removing Polymers in V-Shaped Grooves

Finally, the assembly thus obtained was in order subjected to boiling (for 10 minutes), application of ultrasonics in water (for 10 minutes), a treatment with a hydrofluoric acid buffer (for 10 seconds), application of ultrasonics in water (for 10 minutes), a treatment with a liquid for peeling the resist (for 10 minutes) and application of ultrasonics in water (for 10 minutes) to thus completely remove the polymers 40, 41 present in the V-shaped grooves. The resulting product was then dried (FIGS. 3I-1, I-2).

(6) Step for Dicing

Thereafter, the edge portion of the V-shaped groove was cut off at a predetermined width by dicing and then the wafer-like substrate 10 was cut into individual devices by dicing to thus complete a large number of optical waveguide devices 100.

### Example 2

A silicon wafer having a diameter of 76 mm was provided as a substrate 10. The steps such as those for forming a film and for patterning were carried out at a time for the overall surface of the wafer-like substrate 10 and the wafer was ultimately cut into individual devices.

(1) Step for Forming V-Shaped Grooves

V-Shaped grooves 20 each having a depth of about 100 μm and a width of about 140 μm were formed on the surface of the silicon substrate 10 according to the anisotropic etching technique using a 35% potassium hydroxide aqueous solution warmed at 40° C.

(2) Steps for Forming Peelable Layer for Filling Polymer 30

An aluminum chelate-containing coating liquid for forming a filling polymer-containing peelable layer 30 was coated on the substrate 10 on which the V-shaped grooves had been formed at a rotational number for coating of 1000 rpm×30s according to the spin-coating technique. After the completion of the coating operation, the coated layer was cured by heating the same at 150° C. for 30 minutes.

(3) Steps for Coating Filling Polymer 40 and for Removing Unnecessary Portion

The solution of the negative-type photo-sensitive polymer composition (NV=40%) prepared in Preparation Example 2 was applied onto the filling polymer-containing peelable layer 30 at a speed of rotation of 2000 rpm×30s according to the spin-coating technique. Thereafter, the coated layer of the solution was dried by heating the same at 100° C. for 5 minutes.

A mask having the pattern corresponding to the V-shaped grooves was put on the foregoing layer of the negative-type photo-sensitive polymer composition and the layer was exposed to light through the mask under a condition of 150 mJ/cm² and then subjected to a post-heating treatment at 115° C. for 5 minutes. In this connection, the mask used had such a shape that the filling polymer having a picture frame-like structure remained on the periphery of each V-shaped groove. After the exposure, the exposed layer was developed with an aqueous solution of tetramethyl ammonium hydroxide (2.38%) for 100 seconds and then washed with water. After the development, it was cured by heating at 390° C. for 2 hours. At this stage, the distance between the surface of the resulting filling polymer 40 and the substrate surface was found to be 18 μm. In addition, the height of the picture frame structure from the substrate surface was found to be 6 μm.

(4) Step for Forming Optical Waveguide 60

An optical waveguide was formed on the foregoing substrate whose V-shaped grooves had been filled with filling polymer 40 by repeating completely the same procedures used in Example 1, scribed marks were likewise formed and then the polymer present in the V-shaped grooves were removed. Thereafter, the substrate was subjected to dicing to thus complete a large number of optical waveguide devices.

### Comparative Example 1

Optical waveguide devices were produced by repeating the same procedures used in Example 1 except for omitting the steps (2) or the “steps for coating filling polymers 40, 41 and for removing unnecessary portion”.

### Evaluation

Optical waveguide devices produced in Examples 1 and 2 and Comparative Example 1 each were inspected for the extent (quantity) of sagging and running of the core height center (see FIG. 4). The results thus obtained are listed in the following Table 1. Each result shows the scattering observed when the measurement was carried out for a number of devices (n=11).

TABLE 1

| Ex. No. | Ex. 1 | Ex. 2 | Comp. Ex. 1* |
|---|---|---|---|
| Altitude gap between the | −0.25˜0.18 | −0.30˜0.30 | −0.4˜1.6 |
| observed level of core | | | |
| center and the designed | | | |
| level of core center (μm) | | | |

In addition, an optical fiber of φ125 μm was mounted on the V-shaped groove of each device produced in Example 1 or 2 to thus couple the same with the optical waveguide and as a result, it was found that in any case, the optical coupling loss could be controlled to a level on the order of not more than 0.3 to 0.5 dB. On the other hand, the optical coupling loss observed for the device produced in Comparative Example 1 was found to be 0.3 to 0.8 dB. Thus, it would be concluded that the scattering in the optical coupling loss observed for the optical waveguide prepared in Comparative Example was higher than that observed for the optical waveguide of the present invention.

As has been described above, the method of the present invention would permit the significant suppression of the sagging and running extent of the core height center in the proximity to the V-shaped groove as compared with the conventional method. Moreover, the method of the present invention likewise permits the easy production of an optical waveguide device through the smaller number of steps while suppressing the occurrence of any significant sagging and running of the core material. In addition, the method of the present invention permits the production of optical waveguide devices at a high yield and the complete removal of the polymer from the V-shaped groove thereof.

### BRIEF DESCRIPTION OF THE DRAWINGS

FIG. 1 is a diagram showing a wafer on which V-shaped grooves are formed.

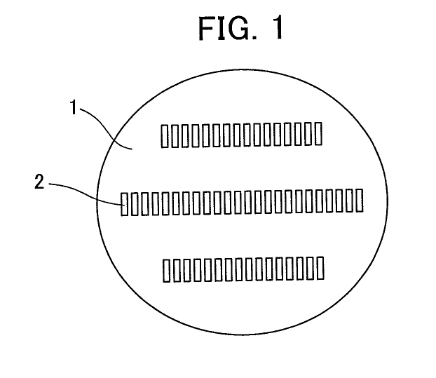

FIG. 2 is a diagram illustrating the steps for the production of optical waveguide devices according to the method of the present invention.

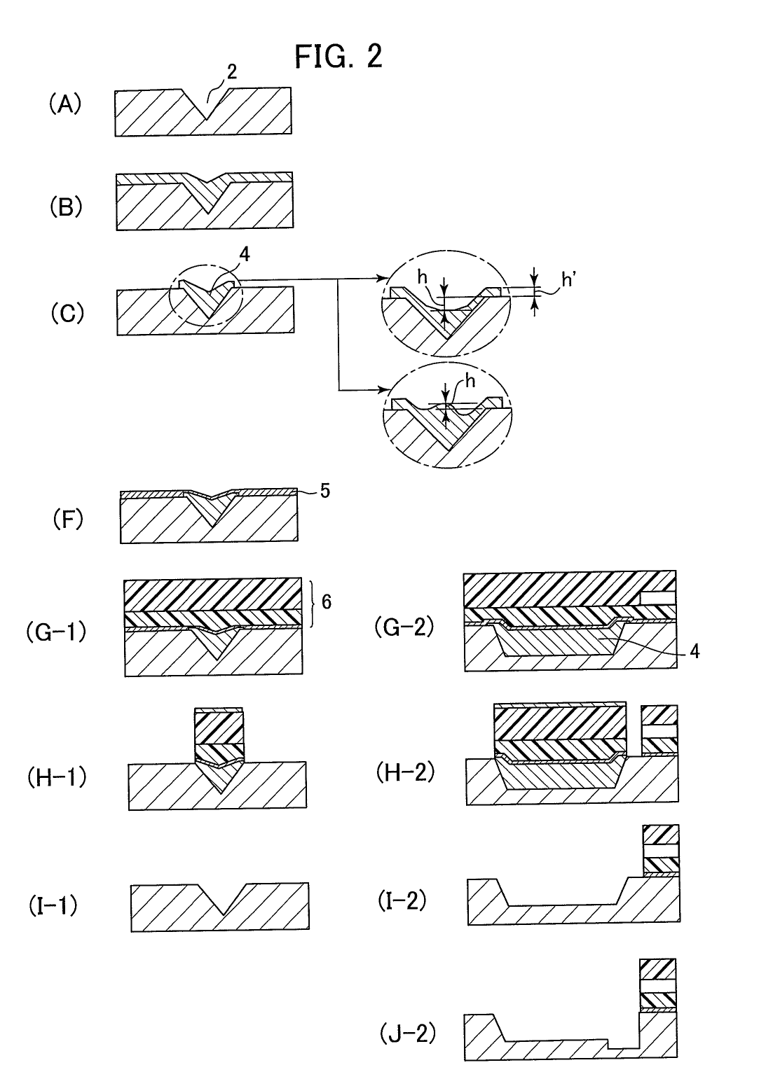

FIG. 3 is a diagram illustrating the steps for the production of optical waveguide devices according to the method of the present invention.

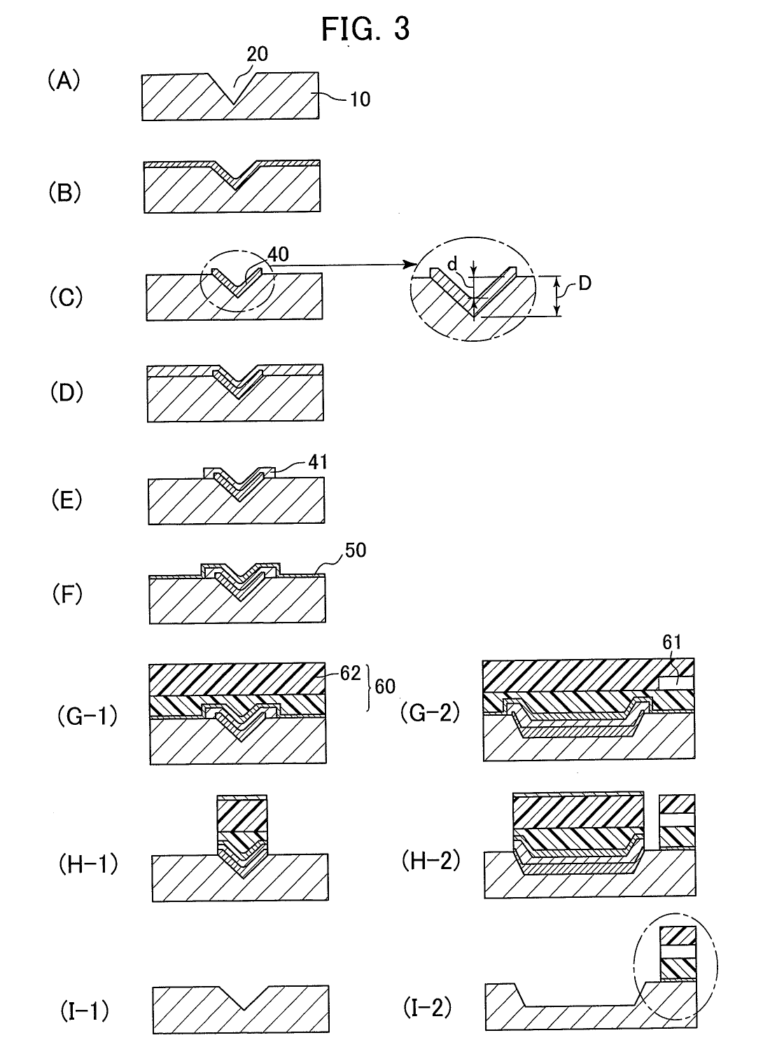

FIG. 4 is a diagram showing the extent of sagging and running of the core height.

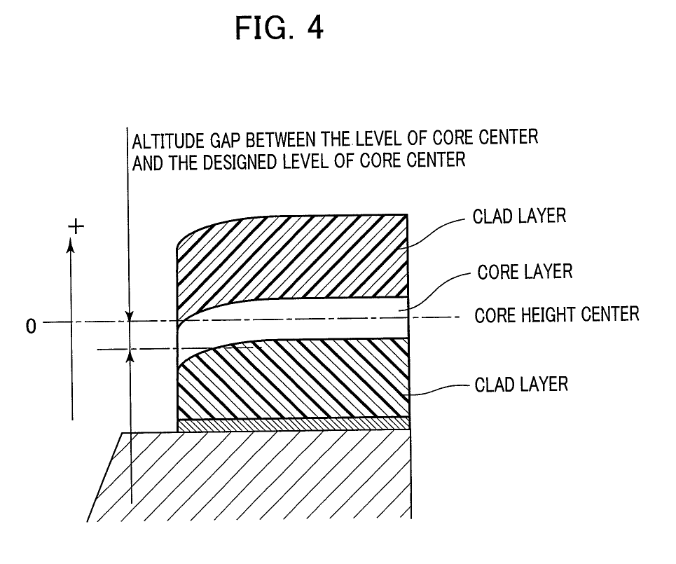

### EXPLANATION OF SYMBOLS

1, 10: Substrate; 2, 20: V-Shaped Groove; 30: Peelable Layer for Filling Polymer; 4, 40, 41: Filling Polymer; 5, 50: Adhesive Layer for Optical Waveguide; 6, 60: Optical Waveguide; 61: Core; 62: Clad

1. A method for preparing an optical waveguide device which comprises, on a substrate, an optical waveguide made of a polymer and a V-shaped groove for mounting an optical fiber to be connected to the optical waveguide, wherein the method comprises the following steps:
(1) a step for forming a V-shaped groove on the substrate;
(2) a step for applying a filling polymer-containing coating solution having an NV (content of non-volatile components) value of not less than 35% onto the substrate, drying the applied coating solution, and then removing the unnecessary filling polymer so that the filling polymer remains only in the V-shaped groove;
(3) a step for forming an optical waveguide consisting of a polymer on the substrate;
(4) a step for making a cut at a position corresponding to the end face of the optical waveguide; and
(5) a step for removing all the polymer present in and on the V-shaped groove.

2. The method as set forth in claim 1, wherein in the step (2), the filling polymer layer is formed by the use of filling polymer-containing coating solutions each having an NV of not less than 35% and repeating, at least two times, the sub-steps of applying each coating solution onto the substrate, drying the applied coating solution, and subsequently removing the unnecessary filling polymer portions.

3. The method as set forth in claim 1 wherein the distance between the surface of the filling polymer remaining in the V-shaped groove and the substrate surface is at a level of not more than 20 μm.

4. The method as set forth in claim 1, wherein the filling polymer is a photo-sensitive polyimide.

5. The method as set forth in claim 4, wherein the sub-step for the removal of the unnecessary portion of the filling polymer in the step (2) comprises exposing the polymer layer to light rays through a mask, developing the exposed polymer layer and curing the same.

6. The method as set forth in claim 5, wherein the sub-step of curing in the step (2) is carried out at a temperature of the Tg of the filling polymer or the Tg of the lowermost filling polymer when at least two layers of different filling polymers are present.

7. The method as set forth in claim 1, wherein the method further comprises a step of applying a peelable layer onto the entire surface of the substrate after (1) the formation of the V-shaped groove and before (2) the application of the filling polymer-containing coating solution.

8. The method as set forth in claim 1, wherein the sub-step for removing the unnecessary portions of the filling polymer in the step (2) is one in which the filling polymer is removed such that the polymer remains in the V-shaped groove and on the periphery of the V-shaped groove.

9. The method as set forth in claim 2, wherein the distance between the surface of the filling polymer remaining in the V-shaped groove and the substrate surface is at a level of not more than 20 μm.
